(19) United States
(12) Patent Application Publication
(10) Pub. No.: US 2016/0026917 A1
(43) Pub. Date: Jan. 28, 2016

(54) RANKING OF RANDOM BATCHES TO IDENTIFY PREDICTIVE FEATURES

(71) Applicant: Causalytics, LLC, Needham, MA (US)

(72) Inventors: Herbert I. Weisberg, Needham, MA (US); Victor P. Pontes, Stoneham, MA (US)

(21) Appl. No.: 14/341,914

(22) Filed: Jul. 28, 2014

(51) Int. Cl. G06N 5/04; G06N 7/00

(52) U.S. Cl. CPC G06N 5/04; G06N 7/005

(57) ABSTRACT

Methods, media, and systems for selecting features that are predictive of a particular outcome from large sets of potentially-predictive features are disclosed. The feature-selection process involves generating random batches of features and ranking the batches according to how accurately a predictive model based on each batch of features performs. Predictive features are selected according to an aggregate rank of the batches in which they are included.

### BACKGROUND

The objective of a predictive modeling algorithm is to generate a highly accurate analytic model to predict the value of an individual's outcome based on her values of potentially predictive features (sometimes called predictors). There are many different statistical and data mining techniques that are in common use, including linear regression, logistic regression, Cox regression, decision trees, neural networks, and support vector machines.

Such methods may be quite useful when the set of relevant predictors is known. However, in many recent applications, particularly those related to genomics and bioinformatics more generally, there may be many more possible predictors than there are data points (observations) available. Moreover, only a few of the predictors may be truly relevant. That is, the great majority of independent features contribute nothing to predictive validity. In effect, their values can be considered purely random. Because there are so many independent features, straightforward utilization of standard statistical modeling methods becomes infeasible.

### SUMMARY

While some systems for dealing with the feature-selection process have been proposed, the present inventors have noted several issues that may limit the effectiveness of such systems. In particular, the inventors have noted the particular combinatorial and overfitting problems.

A combinatorial problem arises because of the astronomical number of possible subsets of the predictive features. Computational limitations foreclose the option of evaluating all possible combinations of potential predictors. So, it is necessary to search through the various possibilities in some efficient fashion, testing only a very small fraction of the total. As a result, it is difficult to ensure that an optimal (or even close to optimal) combination has been found.

Overfitting may result from the fact that so many combinations of features are being examined that some subsets of features are bound to fit the base data well (i.e., produce good predictions) largely by chance. When such a best fit combination is stumbled upon, the estimated accuracy of the model may be spuriously exaggerated. Consequently, a final set of selected features may not generate reliable predictions in practice. A true measure of accuracy can only be obtained through model validation on an independent dataset. However, such after-the-fact validation does not indicate how to improve the model.

Because of overfitting, it may be common to select some features that are not truly relevant (false positives). Conversely, some features that truly are relevant may be missed (false negatives). Consequently, a model that incorporates these apparently relevant features will often perform poorly in independent validation. However, there is no valid statistical test that can indicate the extent to which these two types of errors have occurred. In statistical terms, there is no control for the level of statistical significance (p-value) or guarantee of high power of the feature-selection process. As a result, it may be very difficult to exert error control over the entire process. Moreover, there is no internal measurement of statistical validity provided by the feature-selection procedure itself. So, validation must rely on cross-validation or on testing in an external dataset.

As will be apparent to those of skill in the art, the present embodiments help to alleviate both the combinatorial problem and the overfitting problem. Other advantages may also be inherent in the embodiments described herein.

In one embodiment, an example computer-implemented method involves receiving a set of observed data representing outcomes and, for each outcome, respective feature values for a set of potentially-predictive features. The method also involves selecting batches, which each contain a subset of the potentially-predictive features, and generating an accuracy value for each batch according to the accuracy of a predictive model based on the subset of features in the batch. The method also involves ranking the batches by their accuracy values and determining, for each feature, an aggregate rank of the batches that include that feature. Additionally, the method involves selecting a predictive feature for which the determined aggregate rank of the feature surpasses a predetermined threshold.

In a further embodiment, an example computer-readable medium contains program instructions that, when executed, cause a processor to perform various functions. The functions include receiving a set of observed data representing outcomes and, for each outcome, respective feature values for a set of potentially-predictive features. The functions also include selecting batches, which each contain a subset of the potentially-predictive features, and generating an accuracy value for each batch according to the accuracy of a predictive model based on the subset of features in the batch. The functions also include ranking the batches by their accuracy values and determining, for each feature, an aggregate rank of the batches that include that feature. Additionally, the functions include selecting a predictive feature for which the determined aggregate rank of the feature surpasses a predetermined threshold.

In another embodiment, an example system includes a communication interface configured to receive observed data representing outcomes and, for each outcome, respective feature values for a set of potentially-predictive features. The system further includes a processing system configured to perform a particular set of functions. The functions include receiving a set of observed data representing outcomes and, for each outcome, respective feature values for a set of potentially-predictive features. The functions also include selecting batches, which each contain a subset of the potentially-predictive features, and generating an accuracy value for each batch according to the accuracy of a predictive model based on the subset of features in the batch. The functions also include ranking the batches by their accuracy values and determining, for each feature, an aggregate rank of the batches that include that feature. Additionally, the functions include selecting a predictive feature for which the determined aggregate rank of the feature surpasses a predetermined threshold.

The foregoing is a summary and thus by necessity contains simplifications, generalizations and omissions of detail. Consequently, those skilled in the art will appreciate that the summary is illustrative only and is not intended to be in any way limiting. Other aspects, inventive features, and advantages of the devices and/or processes described herein, as defined by the claims, will become apparent in the detailed description set forth herein and taken in conjunction with the accompanying drawings.

### BRIEF DESCRIPTION OF THE FIGURES

FIG. 1 is a schematic diagram of an example system for performing functions according to an exemplary embodiment.

FIG. 2 is a flowchart of a process according to an exemplary embodiment.

FIG. 3 is a data-level diagram of observation data according to an exemplary embodiment.

FIG. 4 is a data-level diagram of batch selection according to an exemplary embodiment.

FIG. 5 is a data-level diagram showing representations of data elements used in an exemplary embodiment.

### DETAILED DESCRIPTION

### I. Example System Architecture

Functions and procedures described herein may be executed according to any of several embodiments. For example, procedures may be performed by specialized equipment that is designed to perform the particular functions. As another example, the functions may be performed by general-use equipment that executes commands related to the procedures. As still another example, each function may be performed by a different piece of equipment with one piece of equipment serving as control or with a separate control device. As a further example, procedures may be specified as program instructions on a computer-readable medium.

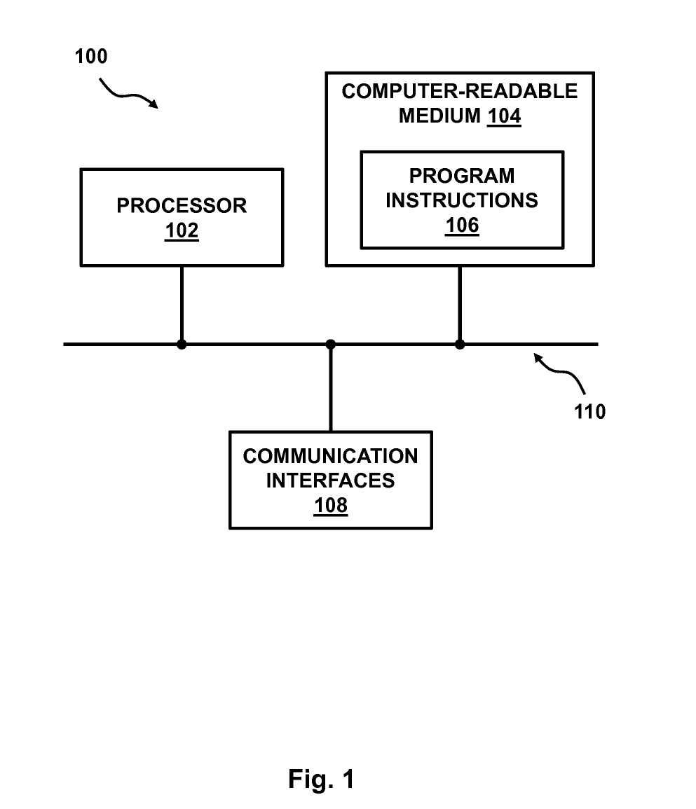

One example system (100) is shown in FIG. 1. As shown, system 100 includes processor 102, computer-readable medium (CRM) 104, and communication interfaces 108, all connected through system bus 110. Also as shown, program instructions 106 are stored on computer-readable medium 104.

Processor 102 may include any processor type capable of executing program instructions 106 in order to perform the functions described herein. For example, processor 102 may be any general-purpose processor, specialized processing unit, or device containing processing elements. In some cases, multiple processing units may be connected and utilized in combination to perform the various functions of processor 102.

CRM 104 may be any available media that can be accessed by processor 102 and any other processing elements in system 100. By way of example, CRM 104 may include RAM, ROM, EPROM, EEPROM, CD-ROM or other optical disk storage, magnetic disk storage or other magnetic storage devices, or any other medium that can be used to carry or store desired program code in the form of program instructions or data structures, and which can be executed by a processor. When information is transferred or provided over a network or another communications connection (either hardwired, wireless, or a combination of hardwired or wireless) to a machine, the machine properly views the connection as a CRM. Thus, any such connection to a computing device or processor is properly termed a CRM. Combinations of the above are also included within the scope of computer-readable media.

Program instructions 106 may include, for example, instructions and data capable of causing a processing unit, a general-purpose computer, a special-purpose computer, special-purpose processing machines, or server systems to perform a certain function or group of functions.

Communication interfaces 108 may include, for example, wireless chipsets, antennas, wired ports, signal converters, communication protocols, and other hardware and software for interfacing with external systems. For example, system 100 may receive observed data via communication interfaces 108 from remote data sources (e.g., remote servers, internet locations, intranet locations, wireless data networks, etc.) or from local media sources (e.g., external drives, memory cards, specialized input systems, wired port connections, wireless terminals, etc.) As another example, system 100 may receive user-input and user-commands via communication interfaces 108 such as, for instance, wireless/remote control signals, touch-screen input, actuation of buttons/switches, voice input, and other user-interface elements. Communication interfaces may also be used to output resulting data.

An example system may also include a variety of devices or elements other than those shown in FIG. 1. For example, system 100 may include visual displays or audio output devices to present results of an example process. As another example, CRM 104 may store computer applications for specific data-generation or data-processing functions. Other examples are possible.

### II. Example Methods

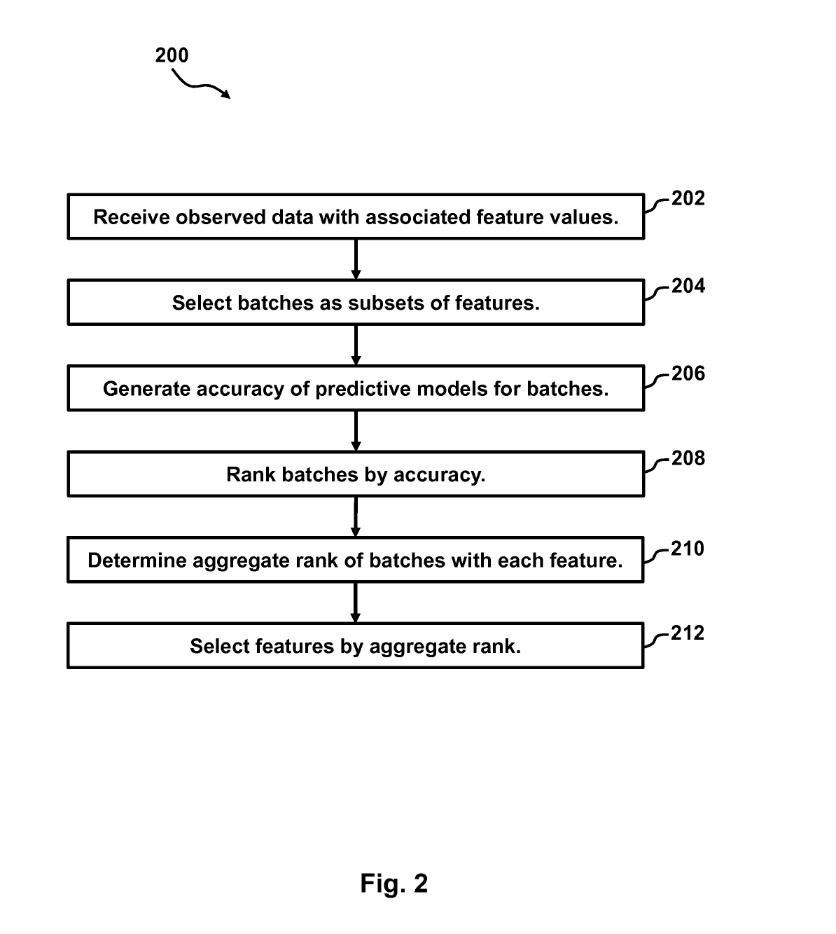

FIG. 2 is a flowchart illustrating a method 200 according to an exemplary embodiment. Method 200 may include additional, fewer, or different operations or steps than those shown, depending on the particular embodiment.

As shown at box 202, method 200 involves receiving observed data with associated feature values for each of a plurality of features. As shown at box 204, method 200 involves selecting batches representing a subset of the plurality of features. As shown at box 206, method 200 involves generating accuracy values for each batch's respective predictive model. As shown at box 208 method 200 involves ranking the batches according to the respective accuracy value of their predictive model. As shown at box 210, method 200 involves determining, for each feature, an average rank of the batches that include the feature. As shown at box 212, method 200 involves selecting features as predictive according to their determined average rank.

### A. Receiving Observed Data

A computing device or system, such as system 100, may receive observed data from a variety of sources and observed data may include various types of information. In some cases, observed data may be received from a single source all at once. In other cases, observed data may be received from several sources and/or over several receiving steps. Observational data may be received, for example, via communication interfaces 108 from local or remote external sources. In some case, data may be received periodically. In other cases, the data may be received through a synchronous or asynchronous push operation from the external sources or pull operation from system 100. In some cases, the source of observed data may be the originator of such data (e.g., data collections system, sensing device, input device, etc.)

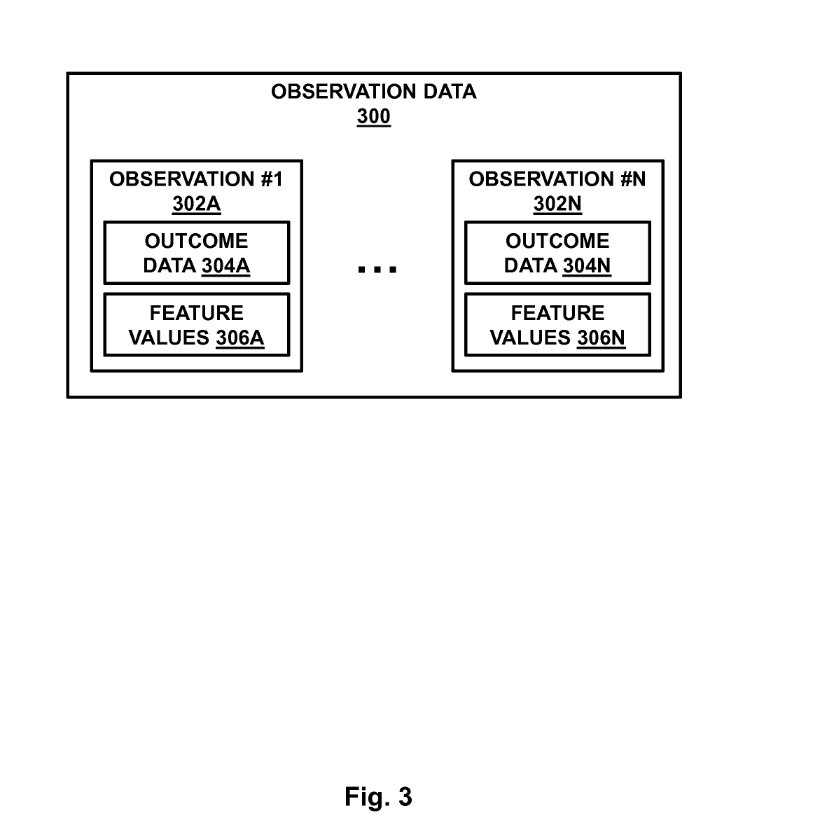

FIG. 3 shows an example structure of the received observational data. As shown, observational data 300 includes a set of observations 302A-N (Observation #1-Observation #N), with each operation 302A-N including outcome data 304A-N and feature values 306A-N. Observation data 300 may include additional information as deemed necessary or preferable in particular embodiment. For example, observation data 300 may include data identifying the particular nature of the observational data, time data was taken or received, data format parameters, security/encoding information, communication protocols, metadata indicators, and/or indications of other related data. Additionally, each observation could include additional information regarding the particular observation. For example, observation data 302A may include identification information for the particular observation, factors not included in outcome data 304A and feature values 306A, units, conversions, communication protocols, application formatting, and/or security/encoding information. In this way, the data for each observation 302A-N may be individually defined separate from observation data 300, as a whole.

In an exemplary embodiment, outcome data 304 may represent the outcome value(s) that the predictive model is intended to predict, and feature values 306 may represent features to be input into the model. In some cases, the data may be taken directly from an experiment or set of experiments. In such a case, it may be quite clear which data should be taken as feature values, and which data should be taken as outcome values. For example, in a study of the efficacy of a new cancer treatment, the outcome value may be the time until remission, and the feature values may include patient/demographic characteristics and the dose of medication given. In other cases, observational data 300 may be received from data collected in previous experiments or taken as a matter of routine. For example, if researchers want to develop a model to predict the likelihood of contracting a particular disease based on certain biomarkers, then feature data may come from routine medical records (e.g., physical examinations, lab tests) and outcome data from routine medical surveillance or population surveys. In such a project, the outcome data 304 and feature values 306 may either be derived from separate sources or may come from a single combined set of data, from which the system may extract the feature values and the outcome values.

Observation data 300 may also store data structures associating the outcome data with its corresponding set of feature values. For example, each observed value (either input or outcome) may be linked to an identifier (e.g., “OBSERVATION #1” for observation 302A), so that a system may treat the observed values associated with one identifier as a single observation by finding all instances of the identifier in received data. Such a format may help if data about the same observation is received from different sources or at different times. In other cases, the structure of the received data may already designate a particular grouping of data. For example, as shown in FIG. 3, a system may store separate observations as particular elements (variables, indexes in a matrix/array, vector locations) of the observed data. In some cases, the observed values may each be associated with a particular participant for which the system receives the participant information. In such cases, the observed data may either identify participants with one or more identifiers (e.g., name or ID number) or identify that each set of data comes from a single participant without identifying the particular participants.

In some cases, several types of outcome data may be relevant. For example, in a study of potential cures for a certain disease, the final condition of a participant (e.g., cured or uncured) and the time-sensitive condition of the participant (e.g., time from treatment to recovery) may both be relevant to the study. As another example, in a study of advertisement efficacy, analysts may be interested in both (i) whether a viewer made a purchase and (ii) how much the purchaser spent. In such cases, a system may perform separate analysis procedures to generate separate models for each relevant outcome. Alternatively, the multiple outcome values may be combined in some fashion to create a derived outcome value that represents an overall response measure. Although the singular terms “observation” and “outcome” may be used herein, each observation may represent such an aggregate of separate outcomes.

Features and outcomes may be measured as categorical, numerical, Boolean, or on any other type of scale. An example of a categorical feature is occupation, since categories like “Florist” and “Senator” do not easily translate to a numerical representation. Examples of numerical features are household income and systolic blood pressure. Other feature types may also be used. Some observed data may include both categorical and numerical predictor features.

In any procedure, all or part of the data may be missing for some observations. For example, human participants may elect to withhold personal information. In particular, for any batch of features, the analysis to calculate the associated accuracy may not be feasible because one or more of the features for that batch has a missing value for certain observations. Therefore, certain potential features may be omitted from some or all such statistical analyses. Alternatively, the features may be included, but with statistical adjustment methods applied for dealing with missing data. In some instances, a system may simply ignore or eliminate the observations for which some necessary data are missing in a particular analysis, but include the observation in analyses that do not include such necessary data. However, if an observation is missing too many feature values, it may be appropriate to exclude that observation entirely from statistical analyses.

In the preferred embodiments, the outcome values and feature values represent real-world measurements, conditions, attributes, and characteristics. The observed data should not be considered simply as abstract numerical data values, but rather as representative of concrete (e.g., physical or behavioral) realities that actually occur in the non-theoretical activities. In some cases, systems physically associated with the present embodiments may perform measurements to create the observed data.

In some cases, a system may receive pre-processed observed data, ready for analysis. In other cases, a system may receive unorganized or raw observed data that must be processed, organized, transformed, and/or filtered before the data can be analyzed. For example, a system that receives two sets of observed data that are formatted differently may need to reformat the sets of data in order to use the sets in a single analysis. As another example, a system may receive potentially-predictive feature values in one set of data and outcomes in a separate set of data. As still another example, a system may create derived features suitable for analysis by transforming raw data into a different form (e.g., converting categorized outcomes into numerical ratings to fit a certain predictive model.) Other examples are also possible.

### B. Selecting Batches

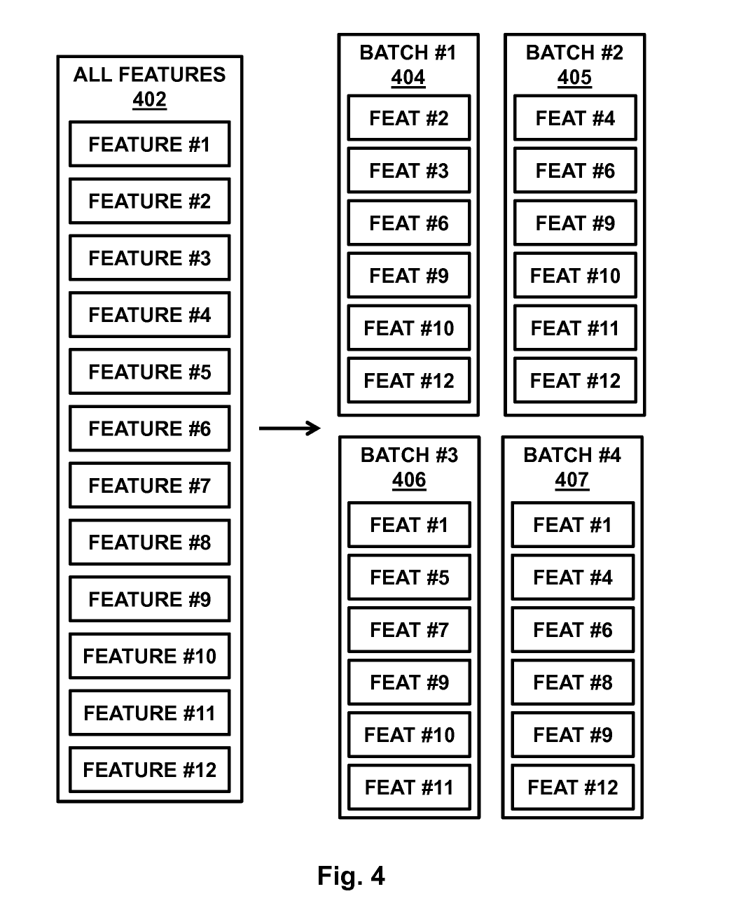

As shown at block 204 of FIG. 2 the system may select batches of feature values to use in the predictive-model generation process. FIG. 4 shows example structures associated with such a batch selection process.

As shown, the batches may be selected from among all received feature values 402 for a particular feature-selection process. In the particular example of FIG. 4, which should not be considered limiting in scope, the set of all features 402 includes twelve features, labeled #1-#12. In some embodiments, feature set 402 may include every feature for which a value has been received by the feature selection system. In other embodiments, features of 402 may include a modified list the features that are being particularly considered as relevant. For example, features at 402 may include only the features for which values have been received for all observations. As another example, feature set 402 may only include features that have a particular form of value (e.g., numerical, categorical, Boolean, etc.) Feature values may be admitted from feature set 402 for other reasons as well.

Also as shown in FIG. 4, the batches (404-407) each contain a subset of the full feature set. FIG. 4 shows a particular embodiment in which four batches of six features each are selected from the twelve features. Accordingly, the example of FIG. 4 appears to use batches which are of an equal and fixed size (in FIG. 4, the fixed size is six features). A fixed batch size is necessary to justify the use of certain statistical testing procedures and may make processing simpler and faster than using variable sizes of batches. However, other embodiments may use a combination of batches of differing sizes. Whether or not the batches are all the same size, batch size may vary inclusively between a single feature and the full set of all features.

In order for the features to be ranked and compared in a completely symmetrical and unbiased manner, the features in each batch must be selected in a manner that is effectively random. The random selection may be performed using any known random selection process. For example, the output of a pseudorandom number generator may be fed into a selection function that chooses the makeup of each batch according to the value of the random input. As another example, the feature values may be selected in a preset pattern, but from a group of features that are sorted randomly.

The system may incorporate safeguards in the batch selection to avoid certain feature selection problems. For example, because the features are chosen randomly, there is the possibility that a particular feature may not be selected for any batch, or selected for too few batches to support a statistical test of significance. Such a problem may be rare in practice and virtually eliminated by selecting a very large number of batches. However to prevent such problems, the system may check the selected batches to ensure that each feature is included in at least a specified threshold number of batches.

For an entirely random selection with fixed batch size (i.e., number of features in the batch), the probability distribution of the number of batches that include each feature is a binomial distribution with an expectation E of:

$$E ( {r}_{i} ) = \frac{rm}{f} , \qquad ( Eq . 1 )$$

where r is the total number of batches selected, rᵢ is the number of batches that include a particular feature i, m is the size of each batch, and f is the total number of potentially predictive features. This formula might be used to determine a value of r that will be considered adequate. For example, suppose we have 1,000 (=f) potentially predictive features and 10 (=m) are included in each batch. Then to obtain approximately 100 batches for each feature, a total of 10,000 batches would be necessary. If the number of features f is large relative to m and the number of batches r is large, the distribution can be approximated by a Poisson distribution.

The system creates a set of r batches from all the potential features without adding or removing batches or features from consideration along the way. Thus, it evaluates all the batches, and through the results obtained then evaluates all the potential features, in a single cohesive process. Since the process does not winnow down or weed out any features along the way, it is far less likely to land on a particular combination of features that performs exceedingly well by chance, but does not truly optimize the model. Such a spurious “overfitting” of the resulting predictive model would result in a model that will perform poorly when tested in a validation sample. Additionally, since features are not removed along the way, the process may be less likely to ignore a truly relevant feature that might substantially improve the predictive validity.

The present inventors recognize that a feature selection process could involve multiple iterations, with features being added and/or removed based on the results of previous iterations. In such an implementation, the total list of features from which the batches are drawn could possibly change based on results of previous iterations, meaning that a new set of batches would be selected for each iteration. While such a process could be implemented using some of the presently disclosed embodiments, and this disclosure is not necessarily limited to excluding such techniques, problems may arise from such a technique. In particular, the repeated reliance on best fit sets of features for determining whether individual features should be eliminated or added to the model at each step increases the probability of ending up selecting some features that yield a good fit only by chance.

The statistical power of the feature selection process (the ability to detect a truly predictive feature) may be directly related to the number of batches generated. Accordingly, a preferable embodiment may utilize a very large number of batches. However, the number of generated batches may be much less than the total number of possible combinations of features. Accordingly, the statistical power of the feature selection may be increased by increasing the number of batches used. However, after a certain point, such increases in power may become small (approach an asymptote) because the number of observations (e.g., patients) in the dataset may also place a limit on the power.

### C. Generating Predictive Models and Accuracy Scores

As shown at block 206 of method 200, an example method may include generating an accuracy score for the respective predictive model based on each batch of features. The process may use any known or forthcoming model building process for creating a respective predictive model for each batch. For example, standard regression techniques may be used to create a mathematical function that relates the provided input features to the observed outcome data. Some examples of regression techniques include linear regression, polynomial regression, logistic regression, Cox regression, decision trees, neural networks, support vector machines, genetic algorithms, LASSO, classification and regression tree (CART) analysis and probit modeling. Other example model-building techniques may be used to fit a statistical model for each batch of features to the observed data.

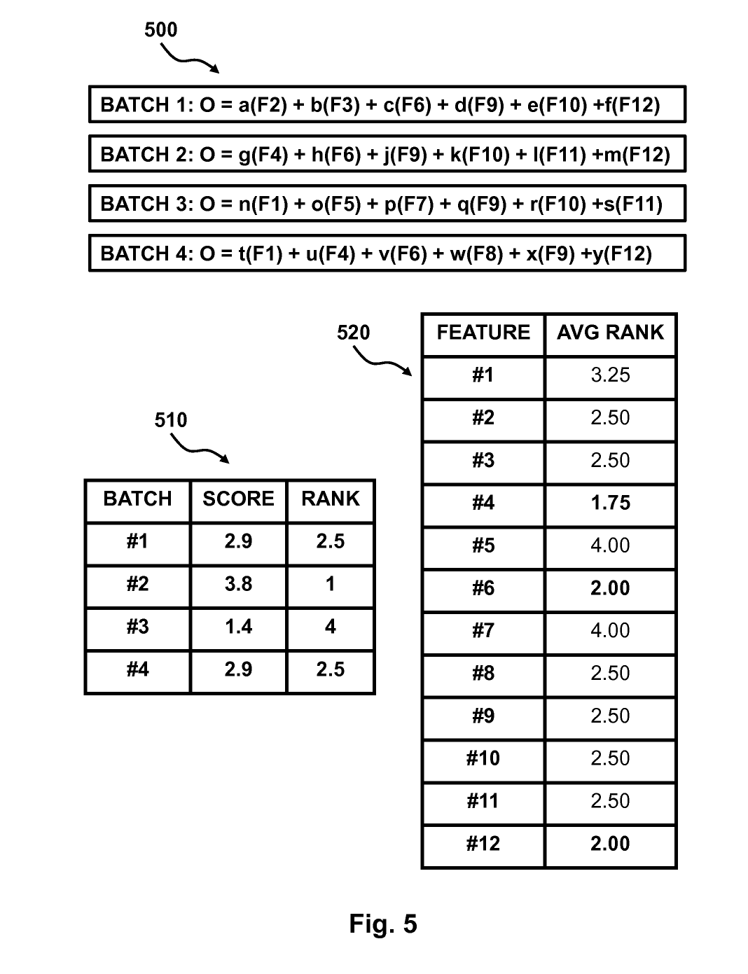

Block 500 of FIG. 5 shows an example result of a model generation process. As shown, a respective predictive function is shown for each of the four batches from FIG. 4. In the particular example of FIG. 5, each model relates the outcome (“O”) to a linear function of the features (“F1”-“F12”) in the batch. Specifically, the value of the features are each weighted by a coefficient (“a”-“y”) and combined linearly to predict the outcome value. As discussed above, the form of the models need not be linear, but may include any function or operation to combine the features in a potentially predictive manner. Accordingly, variable transformations, higher order interactions among variables, and other complex relationships may be used in addition to the variables as originally received to fit the model for each batch of features.

In some cases, the general form of each batch's model may be specified by stored or received instructions. For example, an indication of the model form may be included in the received observation data. As another example, a system may prompt for user-input regarding the model to be used. In other cases, the type of model may be chosen automatically by the system. For example, the system may maintain a default model to use in all cases or when a model is not specified by a user or stored file. As another example, the system may operate a process for selecting a preferable model, based on, for example, optimizing computational costs, superior accuracy score, efficiency of determining accuracy score, etc. In practice, the system may use the same model format/algorithm for each batch in order to improve uniformity and simplify processing.

Since the procedures for selecting the batches, determining an accuracy value for the model, ranking the batches, and determining the aggregate rank for each feature (as will be described below) do not depend on the general form of the model, the present embodiments may be used in nearly identical ways for many different model forms. Indeed, other than the actual model generation/fitting, some embodiments may be entirely unaffected by the selected form of the model.

Once each model has been built, the system may evaluate the accuracy of each model and assign an accuracy score to each model in accordance with how well the model predicts outcome data. Accuracy may be assessed generally as the extent to which the observed outcomes agree with the outcomes predicted by the model. Any known (e.g., R-squared, Akaike information criterion (AIC), Schwarz criterion, focused IC, Hannan-Quinn IC, or area under the curve (AUC), or forthcoming model-accuracy test may be employed in determining the accuracy of each model. Like the model form, the accuracy criterion may be specified by input or determined, based on stored instructions/algorithms, according to the particular circumstances. If analysis of the chosen criterion does not readily provide a numerical accuracy value, the system may assign an accuracy score based on the model's fit to the criterion. Although a single accuracy criterion is mentioned, this criterion may represent an aggregate of multiple accuracy criteria.

In some cases, the accuracy may be assessed by comparing the model's predictions to the outcomes in the same observed data that was used in constructing the model. In other cases, a new set of data (or other data that was not used in model construction) may be used to assess the accuracy of the models. For example, a system may remove (hold aside) some observed data from the received data before using the rest of the received data to build the model and, once the model is built, test the predictions against the removed data. Such a validation process may provide a better indication of true accuracy because the potential effect of overfitting would be substantially reduced.

Once the accuracy scores for each model are obtained, the system may associate the scores with the batches of features for analysis. Accordingly, the system may now store, for each batch, the list of features in the batch, other aspects of the model (e.g., parameters, coefficients), and the model accuracy associated with that set of features.

### D. Ranking Batches and Determining Aggregate Rank of Features

As shown in block 208, an example method may involve ranking the batches according to the accuracy of the model associated with each batch. In an example embodiment, the ranking for each batch may simply be the total number of batches that result in equal or higher accuracy values. Thus, the batch resulting in the Nth highest accuracy would have a rank of N. So, the batch with the highest accuracy would have a rank equal 1. Conversely, the batch with the lowest accuracy would have the rank equal to the total number of potential predictors. In this system, a higher ranking corresponds to a lower value of the rank. For example, a batch with rank 3 would be better than a batch with rank 10. However, the ranking may be performed using any other ranking values including decimal, fraction, integer or string rank values. In the case of ties (more than one batch with exactly the same accuracy value), various possible ways of specifying the ranks are possible. One preferred method is to assign to each of the tied batches the average rank based on their values relative to other batches. For example, suppose that a particular set of four batches all have an accuracy that exceeds 1000 other batches but is lower than 2000 batches. In that case, each of these batches may be assigned the rank value of (2001+2002+2003+2004)/4=2002.5.

An example output of the accuracy-scoring and batch-ranking process is shown at block 510 of FIG. 5. As shown, each batch has been evaluated according to the accuracy criterion and a respective accuracy score has been assigned to the batch. Additionally, each batch has received a rank value according to the accuracy of the batch's model relative to the accuracy of the other batches' models. In the particular example shown in block 510, two batches (#1 and #4) have the same accuracy score (2.9) and, therefore, share the same rank (2.5). In other embodiments, the system may be configured to differentiate between batches that have the same accuracy score so that only a single batch holds each rank. For example, a second accuracy criterion may be used as a tie-breaking technique. Other examples are possible. The manner in which the ranks are assessed may depend on the type of aggregate rank that will be used as described below.

As shown at block 210 of method 200, an example method may include determining, for each feature, an aggregate rank of the batches that include that feature. The aggregate rank is a value representing some summary measure of the rankings of those batches that include a certain feature. For example, block 520 of FIG. 5 shows a list of features and their associated aggregate ranks in accordance with the example batches and ranks shown at other elements of FIGS. 4 and 5. In particular, the aggregate rank shown in block 520 for each feature is the arithmetic mean of the batch ranks for all the batches that include the feature. For instance, Feature #4 is included in batches #2 and #4, which have ranks of 1 and 2.5 respectively. Accordingly, the arithmetic mean of the ranks would be (1+2.5)/2=1.75. Hence, the aggregate rank (labeled as “AVG RANK”) for Feature #4 is listed as 1.75. The value for each feature in block 520 may be computed in a similar way.

In addition to an arithmetic mean, the aggregate rank may include other average (e.g., weighted mean, median, mode, geometric mean, etc.), range (endpoints, quartile ranges, etc.), and/or deviation (variance, standard deviation, etc.) values, as well as any other measures of central tendency, dispersion, or pattern matching. The type of aggregate rank to be used may be specified in stored programs, the user input, or in other instructions received by the processing system.

The system may identify all batches that contain a certain feature using any known technique including hashtables, lookup tables, or direct associations.

### E. Selecting Features

As shown in block 212 of method 200, an example method may involve selecting a set of predictive features according to the aggregate ranks of the features. In some cases, the selection may involve comparing the aggregate rank of each feature to a predetermined threshold value of aggregate rank. For example, in block 520 of FIG. 5 three of the features (#4, #6, and #12) have aggregate rank values better than (i.e., no greater than) 2.00 (shown in bold in block 520). Therefore, if the threshold value were 2.00 for that process, the feature selection process would designate and return these three features as the predictive features to be further considered. In other embodiments, criteria other than a pure threshold level may be used to determine whether a feature is significantly predictive.

In some cases, the threshold aggregate rank for each feature may be determined by a statistical test of significance. There are several ways to perform such a test, including via a classical frequentist hypothesis test or confidence interval approach, or through a Bayesian method, such as a credible interval based on a posterior distribution. The basic idea is to determine whether there is statistical evidence that the particular feature (say feature 1) is truly predictive. That is, we test the null hypothesis that feature i's predictive strength is no better than that of a randomly selected feature. More specifically, we compute the probability (p-value) that a randomly selected set of rᵢ batches would have attained an aggregate rank at least as good as the rᵢ batches that include feature i. The null hypothesis would be rejected and feature i would be deemed predictive if this p-value were less than a specified threshold value. For this purpose, there may be several statistical tests potentially available. If the average rank is used as the measure of aggregate rank, this p-value may be calculated using, for example, the standard formula for the Wilcoxon Rank Sum test, among other possibilities.

If a Wilcoxon test is used, the null-probability distribution of the average rank for the batches that include a feature (feature i) can be proven to be an approximately normal distribution with a mean, μ, and variance, σ, of:

$$\begin{matrix}{μ}_{i} = \frac{r + 1}{2} & ( Eq . 2 ) \\ {σ}_{i} = \sqrt{\frac{( r - {r}_{i} ) ( r + 1 )}{12 {r}_{i}}} & ( Eq . 3 )\end{matrix}$$

From these formulas, the probability under the null hypothesis that the average rank would have been ≦ (i.e., better than) the observed aggregate rank (i.e., the p-value) can be calculated. Note that this procedure may be a “one-sided” test. It is not necessary to entertain the possibility of a true deviation from the null hypothesis in the opposite direction (i.e., worse than random), because a feature cannot truly be “negatively predictive.”

The rationale behind using the Wilcoxon procedure is based on the insight that, under the null hypothesis, there would be nothing unusual about the rᵢ batches that include feature i. In effect, the accuracy values for this set of batches would effectively constitute a random sample of rᵢ batches drawn from some underlying probability distribution of possible accuracy values. Therefore, the probability distribution of the average rank of the estimated accuracy values in the set of batches for any one feature would be like that of a random set consisting of rᵢ observations from this distribution. The Wilcoxon test is designed for just such a situation and is “non-parametric” and therefore “robust.”

In classical statistics, the statistical significance for any parameter is a measure of the extent to which the estimated value of the parameter is consistent with random chance. The usual measure of statistical significance is the p-value, which is the probability that if the parameter were truly zero (or some other specified “null” value), a result at least as extreme as the one actually observed would occur. By extreme is meant deviating from the null hypothesis value. Generally, the smaller the p-value, the less likely that random chance provides a plausible explanation. Statistical significance may be determined in a variety of ways. The particular testing procedure employed depends on the type of statistical model. For example, if OLS regression is used, then the traditional t-test and F-test can be utilized for this purpose.

In an example embodiment, the features are evaluated according to their aggregate ranks, rather than their estimated effects for any of the models that are created based on individual batches. Thus, the evaluation process does not directly seek a “best model” for the data. Rather, the testing finds the features that perform well in general in the context of many other included variables. From the selected features, a single predictive model may then be generated, but the form of the final model can differ from the form that was used during the feature selection process. However, there may be some advantages if the form of the final model is indeed similar to the form of the models used throughout the feature selection process.

Rather than simply performing a test for statistical significance, using a conventional p-value (e.g., 0.05 or 0.01) as the particular threshold value, the p-value may be adjusted to correct for the statistical errors associated with multiple testing. For example, one simple approach is to reduce the required p-value drastically using a Bonferroni correction. For example, suppose that there are f different features being tested in the course of selecting a final model. Then, instead of a conventional p-value of 0.05, a p-value of 0.05/f would be applied. (Equivalently, the nominal p-value obtained may be multiplied byf and the conventional p-value then applied.) For example, a typical feature search algorithm might evaluate hundreds of candidate models to identify one (or a few) finalists. This very stringent corrected cutoff may result in a “family-wide” error rate (FWER) less than 0.05, but can greatly increase the probability of false negative results. More recently developed refinements can improve the number of true discoveries somewhat by being less stringent. These are based on an approach that controls the false-discovery rate, or FDR (Hochberg, 1988; Benjamini and Hochberg, 1995, cited in IDS). For example, in some contexts, it may be reasonable to allow 50% or more false positives, relying on the “imposters” to be weeded out in subsequent validation.

The selection process based on aggregate ranks and including multiple testing corrections is robust test, because it is non-parametric. Under the null hypothesis, the distribution of the aggregate rank statistic does not depend on the particular modeling method or the particular accuracy criterion.

In practice, the “predictive features” determined by statistical testing or otherwise may also be filtered through any number of independent validation processes, to verify the significance of the features. Validation testing may include cross-validation based on the observed data, as well as analyzing data from additional sources (e.g., holdout samples, new samples, historical studies, etc.) to independently confirm a result. For instance, the confirmation could involve examining the how well the selected features predict the outcomes in a new sample of observed data. Features that do not survive independent validation may be removed from the selected predictive features prior to outputting the selected features.

As discussed above, the entire feature selection process may be performed in a single cohesive process. Unlike techniques that would determine the predictive features by repeatedly filtering the features until an optimal set is obtained, this process may help to avoid the overfitting problem and the combinatorial problem associated with feature selection. Additionally, the aggregate-ranking technique for determining significance further helps to prevent overfitting by reducing the potential effect of any one “best fit” set of features.

### F. Generating and Using a Predictive Model

In some cases, an example process may involve generating an algorithm or model, based on the selected predictive features. The model may be created and fitted to observed data using any of the above-referenced techniques or other known methodologies. In such an embodiment, the system may present (display on a screen, transmit to an external device, store to memory) the generated predictive model as a result of the feature selection process. In embodiments that do not generate an actual model, the presented result may be the predictive features, but without any particular model.

One example of an algorithm is a mathematical formula relating the features to the outcome(s). If a particular embodiment fits data to a structure other than a mathematical formula, then the algorithm may use a similar structure. For example, in an embodiment that uses decision tree analysis to relate the predictor features to the outcome, the system may generate a tree-structured algorithm as the resulting model, rather than a formula.

In still other embodiments the system may actually employ the generated model to input data to provide results of a predictive test. For example, a set of features with unknown outcomes may be received by the system or previously stored in the system when the feature-selection procedure is activated. Accordingly, the system may present the results of the feature selection as the predicted outcome values for the unknown set of data.

### III. Example Applications

The example applications are only exemplary to illustrate how methods and systems may be applied to particular problems. Numerous other example situations may also be used.

### A. Example 1

### Genomics

An example of the practical application of the methods is related to prediction of cancer progression. There is currently great interest in identifying genetic or genomic markers that can accurately predict the future course of the disease. Such biomarkers could aid physicians to assess the cost-benefit ratio of various potential treatment options. A recent genomic analysis illustrates the potential application of our methods to assist in this endeavor. The analysis was based on gene expression data for approximately 6,000 genes collected from 358 Swedish prostate cancer patients. This data had been previously analyzed by a group of Harvard-based researchers (Penney et al., 2011). Their ultimate goal was to derive a predictive model to distinguish between patients with slow-growing cancers from those with fast-growing cancers.

As an initial step, they built a model meant to distinguish between the 109 patients with a low Gleason Grade (≦6) and the 98 patients with a high Gleason Grade (≧8). The Gleason Grade is determined by pathological examination of a tumor sample and is currently considered the best routinely available measure of likely cancer progression. The rationale for the study was that a predictive model based on genes whose expression pattern could predict the Gleason Grade well might also be a good (and possibly even superior) predictor of cancer progression.

The Harvard researchers obtained a gene expression signature based on using a standard methodology: prediction analysis of microarrays, or PAM. Their predictive model included 157 genes and was quite accurate as estimated in the Swedish sample. The value of the area under the ROC curve, or AUC, a common measure of accuracy, was 0.91. An independent analysis of the same data was undertaken using the methods described in this patent application. This analysis resulted in a much more parsimonious model, based on only 11 genes, that was apparently even more predictive. The resulting AUC in the Swedish sample was 0.94.

### B. Example 2

### Business Analytics

Another example of the practical application of the methods is related to the retention of patients by a large medical clinic. The data were provided by the Cleveland Clinic as part of the 2013 competition sponsored by the Direct Marketing Association. The clinic desired to understand how best to target former patients who had apparently discontinued. The data made available to the competitors consisted of several hundred potential predictors. The sample of observations consisted of data on 75,000 lapsed patients.

The dependent variable of interest was the visit margin, a measure of how much net income was attributable to a patient visit. An example approach involved two separate models that were combined to obtain an expected visit margin for each patient in a hold-out sample used for model validation. One example was used to predict the probability that the patient responded to the campaign; the other model, which was applicable only for those who responded, attempted to predict the dollar amount of the resulting visit margin.

For each of the two models, the example methods described herein were applied. In each case, the algorithm was applied in two stages. In the first stage, a subset of approximately 50 potentially relevant predictors was determined. In the second stage, the method was applied to this subset of the variables, resulting in a final set of less than 10 variables. For the first (response) model, a logistic regression was derived, since the outcome was a binary variable. For the second (margin) model, an OLS regression model was derived, since the outcome had a continuous numerical value.

The resulting response model was highly predictive and potentially very useful. The AUC of 0.80 based on six key variables was able to differentiate well among the patients in terms of their likelihood of responding to the campaign. With respect to the visit margin, the methodology was able to determine that the available variables were incapable of differentiating patients to a meaningful extent. This “negative” finding was important, because it implied that focusing on refinement of the response model should become a priority. There was no way to improve upon simply attributing the overall average margin to each individual.

Based on the findings obtained using the methodology, an expected visit margin for each individual was calculated by multiplying the predicted probability of responding times the average margin for all responders. The criterion used in the DMA Challenge for ranking the entrants was the root mean squared error (RMSE) obtained in a hold-out sample. The results obtained using the example methods described herein achieved a better performance (lower RMSE) than the winning entry in the actual competition. This proof of concept illustrates the potential benefits of the methodology for optimization of database marketing and other business-related processes.

### IV. Conclusion

The feature-selection problem arises in many contexts. While the present disclosure includes the perspective and terminology from the field of statistics, essentially the same problem appears also in many applications usually categorized under the rubric of machine learning or artificial intelligence (AI). In machine learning, many classification, pattern recognition and language processing techniques are based on feature selection. In a sense, statistical methods can be regarded as just a particularly important subset of machine learning or AI methods.

The construction and arrangement of the elements of the systems and methods as shown in the exemplary embodiments are illustrative only. Although only a few embodiments of the present disclosure have been described in detail, those skilled in the art who review this disclosure will readily appreciate that many modifications are possible (e.g., variations in structures, shapes, and proportions of the various elements, values of parameters, arrangements, etc.) without materially departing from the novel teachings and advantages of the subject matter recited.

Additionally, in the subject description, the word “exemplary” is used to mean serving as an example, instance or illustration. Any embodiment or design described herein as “exemplary” is not necessarily to be construed as preferred or advantageous over other embodiments or designs. Rather, use of the word exemplary is intended to present concepts in a concrete manner. Accordingly, all such modifications are intended to be included within the scope of the present disclosure. The order or sequence of any process or method steps may be varied or re-sequenced according to alternative embodiments. Any means-plus-function clause is intended to cover the structures described herein as performing the recited function and not only structural equivalents but also equivalent structures. Other substitutions, modifications, changes, and omissions may be made in the design, operating conditions, and arrangement of the preferred and other exemplary embodiments without departing from scope of the present disclosure or from the scope of the appended claims. For the purposes of the disclosure, the term “or” is interpreted to be inclusive, and may be used interchangeably with “and/or” according to readability.

Although the figures show a specific order of method steps, the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques using rule-based logic and data storage/reading and/or other logic to accomplish the various connection steps, processing steps, comparison steps and decision steps.

What is claimed is:

1. A method comprising:
receiving observed data representing a set of outcome values and, for each outcome value, a set of corresponding feature values for a set of potentially-predictive features;
selecting a plurality of batches, wherein each batch is a randomly selected subset of features from the set of potentially-predictive features;
generating, for each respective batch of the plurality of batches, an accuracy value for a predictive model based on the subset of features associated with the respective batch;
ranking the plurality of batches according to the generated accuracy values for each batch;
determining, for each respective feature in the set of potentially-predictive features, an aggregate rank for the subset of batches that include the respective feature; and
selecting, as predictive features, features from the set of potentially-predictive features for which the determined aggregate rank satisfies a predetermined criterion.

2. The method of claim 1, wherein satisfying the predetermined criterion comprises the aggregate rank surpassing a predetermined non-zero threshold.

3. The method of claim 1, wherein each of the selected plurality of batches comprises the same number of features.

4. The method of claim 1, wherein the set of potentially-predictive features represents a complete set of known features indicated in the data, and wherein the random selection is not filtered prior to selection.

5. The method of claim 1, wherein the predictive features are selected based on an analysis of a single plurality of batches.

6. The method of claim 5, wherein the single plurality of batches are all selected prior to ranking any of the plurality of batches.

7. The method of claim 1, further comprising:
generating a respective predictive model for the respective subset of features associated with each respective batch; and
fitting the predictive model for each batch to the data representing the set of observations.

8. The method of claim 7, further comprising receiving a selection of a general form of a desired predictive model, wherein each batch is applied to the data in accordance with the selected general form of the desired predictive model.

9. The method of claim 1, wherein selecting the predictive features comprises:
calculating, for each respective feature in the set of potentially predictive features, a null-hypothesis probability (p-value) that the aggregate rank of a randomly selected subset of batches is at least as good as the determined aggregate rank for the respective feature; and
selecting a predictive feature based on a determination that the null-hypothesis probability (p-value) associated with the predictive feature is less than or equal to a predetermined threshold probability.

10. The method of claim 9, further comprising adjusting the predetermined threshold probability in accordance with a quantity of tests being evaluated.

11. The method of claim 9, wherein the null-hypothesis probability is calculated using a non-parametric statistical test to obtain a nominal null-hypothesis probability.

12. The method of claim 11, further comprising adjusting the predetermined threshold probability in accordance with a quantity of tests being evaluated.

13. A non-transitory computer-readable medium having stored thereon program instructions executable by a processor to cause the processor to perform functions comprising:
receiving observed data representing a set of outcome values and, for each outcome value, a set of corresponding feature values for a set of potentially-predictive features;
selecting a plurality of batches, wherein each batch is a randomly selected subset of features from the set of potentially-predictive features;
generating, for each respective batch of the plurality of batches, an accuracy value for a predictive model based on the subset of features associated with the respective batch;
ranking the plurality of batches according to the generated accuracy values for each batch;
determining, for each respective feature in the set of potentially-predictive features, an aggregate rank for the subset of batches that include the respective feature; and
selecting, as predictive features, features from the set of potentially-predictive features for which the determined aggregate rank satisfies a predetermined criterion.

14. The computer-readable medium of claim 13, wherein satisfying the predetermined threshold comprises the aggregate rank surpassing a predetermined non-zero threshold.

15. The computer-readable medium of claim 13, wherein the predictive features are selected based on an analysis of a single plurality of batches, wherein the single plurality of batches are all selected prior to ranking any of the plurality of batches.

16. The computer-readable medium of claim 13, wherein the functions further comprise:
receiving a selection of a general form of a desired predictive model;
generating a respective predictive model for the respective subset of features associated with each respective batch, wherein each predictive model is generated in accordance with the selected general form of the desired predictive model; and
fitting the predictive model for each batch to the data representing the set of observations.

17. A computing system comprising:
a communication interface configured to receive observed data representing a set of outcome values and, for each outcome values, a set of corresponding feature values for a set of potentially-predictive features;
a processing system configured to perform functions comprising:
receiving data representing a set of observation values, wherein each observation value is associated with a set of corresponding feature values for a set of potentially-predictive features;
selecting a plurality of batches, wherein each batch is a randomly selected subset of features from the set of potentially-predictive features;
generating, for each respective batch of the plurality of batches, an accuracy value for a predictive model based on the subset of features associated with the respective batch;
ranking the plurality of batches according to the generated accuracy values for each batch;
determining, for each respective feature in the set of potentially-predictive features, an aggregate rank for the subset of batches that include the respective feature; and
selecting, as predictive features, features from the set of potentially-predictive features for which the determined aggregate rank satisfies a predetermined criterion.

18. The computing system of claim 17, wherein the predictive features are selected based on an analysis of a single plurality of batches, wherein the single plurality of batches are all selected prior to ranking any of the plurality of batches.

19. The computing system of claim 17, wherein the processing system is further configured to:
receive a selection of a general form of a desired predictive model;
generate a respective predictive model for the respective subset of features associated with each respective batch, wherein each predictive model is generated in accordance with the selected general form of the desired predictive model; and
fit the predictive model for each batch to the data representing the set of observations.
